(19) United States
(12) Patent Application Publication
(10) Pub. No.: US 2014/0063511 A1
(43) Pub. Date: Mar. 6, 2014

(54) IMAGE FORMING APPARATUS AND IMAGE FORMING SYSTEM

(71) Applicants: Kabushiki Kaisha Toshiba, Tokyo (JP); Toshiba Tec Kabushiki Kaisha, Tokyo (JP)

(72) Inventor: Hajime TOMIZAWA, Shizuoka (JP)

(73) Assignees: Kabushiki Kaisha Toshiba, Tokyo (JP); Toshiba Tec Kabushiki Kaisha, Tokyo (JP)

(21) Appl. No.: 13/952,330

(22) Filed: Jul. 26, 2013

(30) Foreign Application Priority Data
Sep. 6, 2012 (JP) 2012-195708

(51) Int. Cl. H04N 1/60; G06K 15/02

(52) U.S. Cl. CPC H04N 1/6097; G06K 15/1878
USPC 358/1.2; 358/1.9

(57) ABSTRACT

According to one embodiment, an image forming apparatus includes a printing section configured to print on a sheet an image formed on an original, a determination section configured to determine whether or not the image formed on the original is formed with an erasable material, and a conversion section configured to change a color of the image to be printed by the printing section if the determination section determines that the image formed on the original is formed with the erasable material.

### CROSS-REFERENCE TO RELATED APPLICATION

This application is based upon and claims the benefit of priority from Japanese Patent Application No. 2012-195708, filed Sep. 6, 2012, the entire contents of which are incorporated herein by reference.

### FIELD

Embodiments described herein relate to processing of an image formed of erasable color material.

### BACKGROUND

According to conventional technology, a paper sheet is reused by repeatedly erasing an image that is printed on the paper sheet with an erasable color material such as a color-erasable toner. In addition, there exists an image forming system in which a density of an image to be formed is corrected, e.g., increased, and the image is printed with the corrected density, if it is determined that the image is to be formed using an erasable color material.

### BRIEF DESCRIPTION OF THE DRAWINGS

FIG. 1 is a system block diagram illustrating an image forming system according to a first embodiment.

FIG. 2 is a diagram illustrating an example of an original formed with an identification mark.

FIG. 3 is a diagram illustrating an example of document creation information.

FIG. 4 is a diagram illustrating the creation history of document data.

FIG. 5 is a flowchart illustrating a print processing using a general color material.

FIG. 6 is a diagram illustrating management information of an MFP information management section that tracks the relationship between an MFP and a material that the MFP uses.

FIG. 7 is a diagram illustrating a print setting screen for a color-erasable original according to a second embodiment.

FIG. 8 is a diagram illustrating an example of a document printed in accordance with the print setting shown in FIG. 7.

### DETAILED DESCRIPTION

According to one embodiment, an image forming apparatus includes a printing section configured to print on a sheet an image formed on an original, a determination section configured to determine whether or not the image formed on the original is formed with an erasable material, and a conversion section configured to change a color of the image to be printed by the printing section if the determination section determines that the image formed on the original is formed with the erasable material.

The image forming apparatus according to one embodiment herein is described below with reference to accompanying drawings.

### First Embodiment

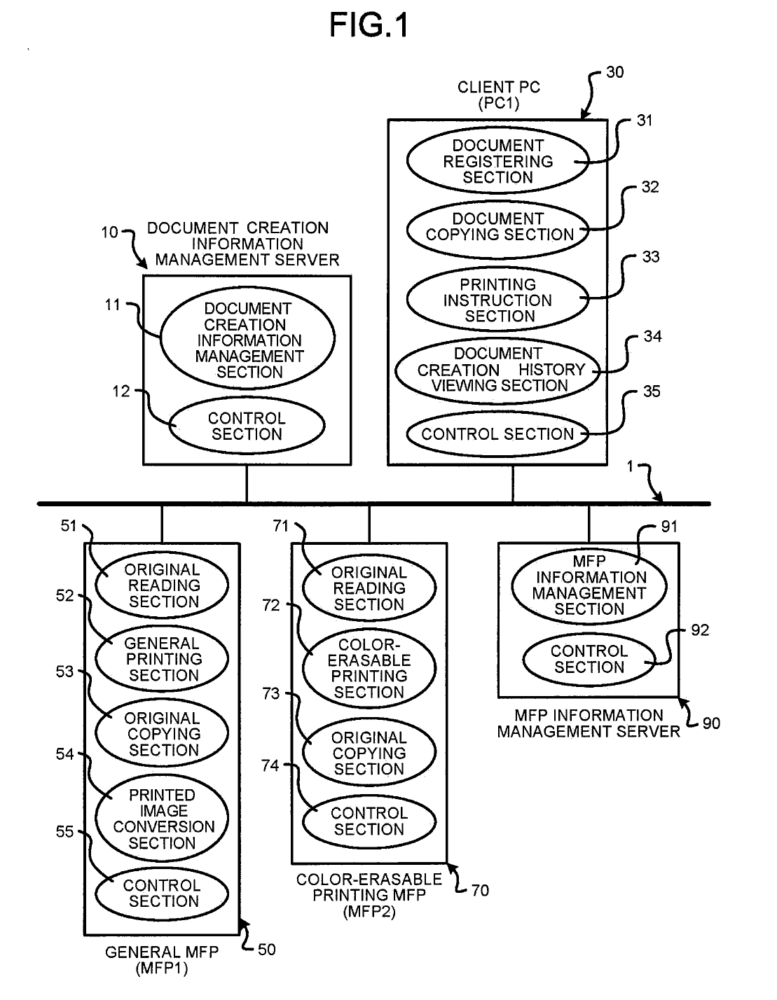

FIG. 1 is a system block diagram illustrating an image forming system according to a first embodiment.

As shown in FIG. 1, the image forming system has a document creation information management server 10, a client PC 30, a general MFP (first MFP) 50, an color-erasable printing MFP (second MFP) 70, an MFP information management server 90, and a network 1.

The document creation information management server 10 comprises a document creation information management section 11 and a control section (CPU) 12 for controlling the whole document creation information management server.

The client PC 30 comprises a document registering section 31, a document copying section 32, a printing instruction section 33, a document creation history viewing section 34, and a control section 35 for controlling the whole client PC 30.

The general MFP (first MFP) 50 comprises an original reading section 51, a general printing section 52, an original copying section 53, a printed image conversion section 54, and a control section 55 for controlling the whole general MFP 50.

The color-erasable printing MFP (second MFP) 70 comprises an original reading section 71, a color-erasable printing section 72, an original copying section 73, and a control section (CPU) 74.

The MFP information management server 90 comprises an MFP information management section 91 and a control section (CPU) 92 for controlling the whole MFP information management server 90.

The network 1 is connected with the client PC 30, the document creation information management server 10, the general MFP 50, the color-erasable printing MFP 70, and the MFP information management server 90, so that these apparatus can communicate with each other.

(1) Document Creation Information Management Server 10

The document creation information management server 10 manages document creation information using the document creation information management section 11. As shown in FIG. 3, the document creation information includes an identification number, a creation date and time, a created location, a state, and identification number of its original document data. Here, the identification number is a number for uniquely identifying document creation information.

In one embodiment, the document creation information management section 11 manages an electronic document file and a physical document. The management is achieved by adding an identification number of document creation information in the electronic document file or the document to be printed to associate the document creation information with the electronic document file or the physical document.

As to an electronic document file, the identification number of the electronic document file is added on the file. For example, the identification number may be added in a PDF file as a property of the PDF file. In this way, the document creation information stored in the document creation information management section 11 can be referred to based on the identification number added in the property of the PDF file.

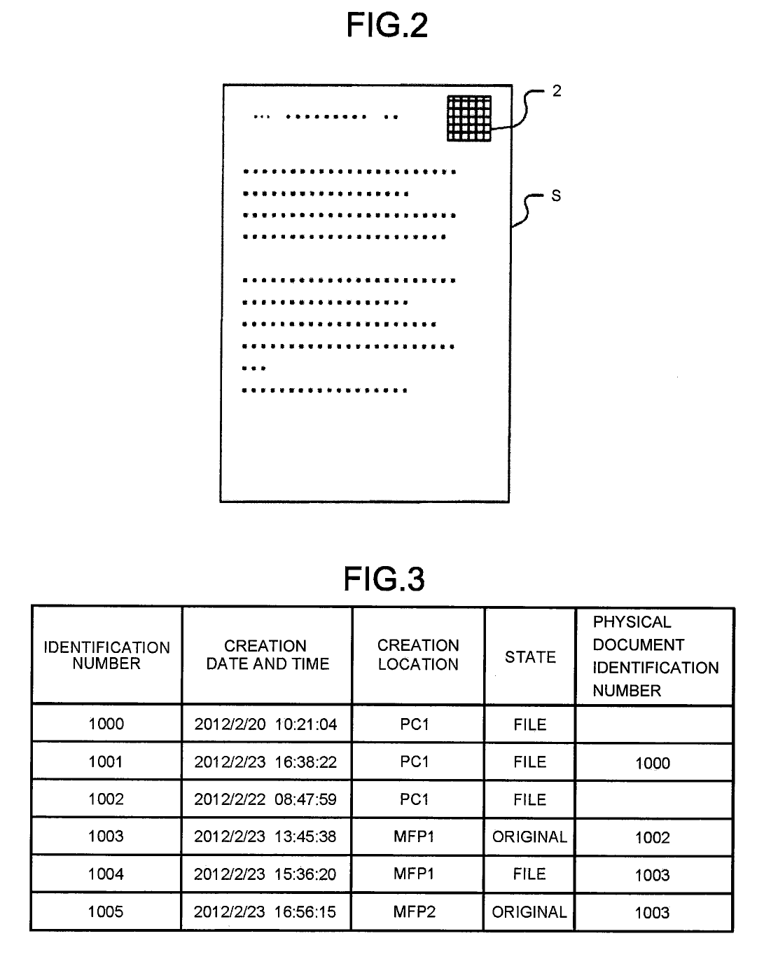

On the other hand, as to a physical document, an identification number may be added at a position in an original image and then printed. For example, as shown in FIG. 2, an identification mark 2, such as a QR code (registered trademark) and the like, representing an identification number is added on the right upper part of the original image to be printed. In this way, the identification number of the printed document can be acquired by reading the identification mark 2 printed on the physical document, and based on the identification number the document creation information stored in the document creation information management section 11 can be referred.

FIG. 3 illustrates an example of the document creation information managed by the document creation information management section 11. The creation date and time of document creation information represents the date and time when the document is created as an electronic document file or a physical document. The item “created location” in FIG. 3 represents a location at which the document is created. For example, if a PDF file is created at the client PC 30, then the host name of the client PC30 is stored as the created location. In addition, if a physical document is printed by the general MFP 50, then the host name of the general MFP 50 is stored as the created location.

The item “state” indicates whether or not the document data is an electronic file or a physical document printed using paper. The item “original document data” represents the identification number of the original document based on which the document is created. For example, it is assumed that the identification number of the PDF file managed by the document creation information management section 11 is 1000. In this case, if the PDE file of which identification number is 1000 is copied and the copied PDF file with an identification number of 1001 is managed, then the “original document data” of the PDF file identified by the identification number 1001 is 1000.

(2) Client PC 30

The processing of determines an electronic document file stored in the client PC 30 as a management object of the document creation information management section 11 by the document registering section 31 is described below.

If a document file is designated in the document registering section 31 provided in the client PC 30, then the document registering section 31 creates new document creation information for managing the designated document file and adds the new document creation information to the document creation information management section 11. In this way, the document creation information of the identification number 1000 is added to a table shown in FIG. 3.

Here, as the document file (identification number 1000) became a management object of the document creation information management section 11 by the document registering section 31 in the client PC30 creating it, the “creation date and time” is registered as the date and time when the document registering section 31 created the document file, e.g. (2012/2/20 10:21:04). Further, the “created location” is registered as the host name of the client PC 30, that is, ‘PC1’. Here, as the electronic document file is registered, the state is registered as ‘electronic file’. Further, as there is no document data serving as the original of this electronic document file, the “original document data” is null. At the same time, the document registering section 31, which adds and registers the document creation information to the document creation information management section 11, adds the identification number of the added and registered document creation information, which refers here to 1000, to the electronic document file, which is a management object.

In this way, the document creation information of a document file can be acquired by reference to the document creation information management section 11 using the identification number contained in the document file becoming a management object.

The processing of copying the electronic document file managed by the document creation information management section 11 in the client PC 30 is described below. It is considered here to copy the electronic document file identified by the identification number 1000 shown in FIG. 3.

If a document file, as a copy object, is designated in the document copying section 32 provided in the client PC 30, then the document copying section 32 adds and registers the document information of the document file newly created by being copied to the document creation information management section 11 while copying the original document file.

Specifically, first, the document copying section 32 creates new document creation information for managing the document file newly created by being copied and adds and registers the new document creation information to the document creation information management section 11. In this way, the document creation information of the identification number ‘1001’ shown in FIG. 3 is added and registered. Next, the document copying section 32 copies the original document file and adds the identification number of the newly added and registered document creation information, which refers here to 1001, to the newly-created electronic document file.

Here, the document file of the identification number ‘1001’ is obtained by copying the original document file of the identification number ‘1000.’ Thus, the identification number 1000 is registered in the document creation information as the “original document data” of the identification number ‘1001’.

Thus, by referring to the document creation information of a document file using the identification number contained in the document file, it can be known that the document file is created by copying another document file.

(3) Document Creation Information Management Server 11

The processing of printing the document file managed by the document creation information management section 11 using the general MFP 50, the host name of which is ‘MFP1’, is described below. It is assumed here to print the document file managed by the identification number ‘1002’ shown in FIG. 3.

If a document file, as a print object, is designated in the printing instruction section 33 provided in the client PC 30, then, a printing is carried out using a designated printing device.

First, the printing instruction section 33 creates new document creation information for managing a physical document output by the printing and adds and registers the new document creation information to the document creation information management section 11. In this way, the document creation information of the identification number ‘1003’ shown in FIG. 3 is added and registered.

Next, the printing instruction section 33 creates printing data, such as Post Script and the like from the document file serving as a print object.

The printing instruction section 33 adds the image of identification mark 2 representing the identification number of the added and registered document creation information, which refers here to 1003, to the printing data, and sends the printing data to which the image of the identification mark 2 is added to the designated printing device to be printed.

Here, as the document creation information of identification number ‘1003’ shown in FIG. 3 is obtained by printing the document file of identification number ‘1002’, identification number ‘1002’ is registered as “original document data.” Further, as the document data shown with identification number ‘1003’ is a physical document, the state is registered as ‘physical document’, and the “created location” is registered as the host name of the general MFP that carried out the printing, that is, ‘MFP 1’.

In this way, the document creation information of the physical document can be acquired by acquiring an identification number from the identification mark 2 printed on the printed physical document.

(4) The processing of scanning an original physical document managed by the document creation information management section 11 using the general MFP 50, the host name of which is ‘MFP1’, is described. It is assumed here to scan the original physical document managed with the identification number ‘1003’ shown in FIG. 3 to acquire image data. The original physical document may be scanned using the original reading section 51 of the general MFP 50 or the original reading section 71 of the color-erasable printing MFP 70, thereby acquiring the data of the original image read by the original reading section 51 or 71 to create an electronic document file. Further, the original physical document may be read using the original reading section 51 of the general MFP 50.

The original reading section 51 reads the original placed on an original table to acquire image data to create a document file. The original reading section 51 reads the identification mark contained in the image data. Thus, identification number 1003 may be acquired from the original.

Next, the original reading section 51 creates new document creation information for managing the created electronic document file and adds and registers the new document creation information to the document creation information management section 11. In this way, the document creation information of the identification number 1004 shown in FIG. 3 is added and registered. Sequentially, the original reading section 51 adds the identification number of the added and registered document creation information, which refers here to 1004, to the created electronic document file.

Here, as the document creation information of the identification number 1004 shown in FIG. 3 is obtained by scanning the original physical document of identification number 1003, identification number 1003 is registered as “original document data.” Further, as the scanning is carried out in the general MFP 50, ‘MFP1’ is registered as the “created location.” In addition, as the document data of identification number 1004 is an electronic document file created by the scanning, ‘file’ is registered as the “state”.

(5) The processing of copying the original physical document managed by the document creation information management section 11 is described. It is assumed herein to copy the original physical document managed by the identification number 1003 shown in FIG. 3 using the color-erasable printing MFP 70, the host name of which is ‘MFP 2.’

The original physical document can be copied by the original copying section 53 of the general MFP 50 or the original copying section 73 of the color-erasable printing MFP 70. The copying of the original physical document by the color-erasable printing MFP 70 is exemplarily illustrated here.

First, the original copying section 73 reads the original physical document placed on an original table to acquire image data.

Next, the original copying section 73 reads the identification mark 2 contained in the image data. Here, identification number 1003 can be read from the original physical document. The original copying section 73 creates new document creation information for managing the physical document generated by the copying and adds and registers the new document creation information to the document creation information management section 11. In this way, the document creation information with the “identification number” 1005 shown in FIG. 3 is added and registered.

Then, the original copying section 73 creates printing data to be copied from the acquired image data, and replaces the image of the identification mark 2 representing the identification number of the added and registered document creation information which refers here to 1005, with the image of the existing identification mark 2 contained in the printing data. Next, the printing data added with the image of the identification mark 2 is printed.

Here, as the document creation information with the identification number 1005 shown in FIG. 3 is obtained by copying the original physical document with identification number 1003, identification number 1003 is registered as the “original document data.” Further, as the copying is carried out by the color-erasable printing MFP 70, ‘MFP2’ is registered as the “created location,” additionally, as the document data of identification number 1005 is the physical paper document created by the copying, ‘physical document’ is registered as the “state.”

By managing the document creation information of an electronic document file or an physical document using the document creation information management section 11 in this way, the creation history of the document data can be acquired. The acquisition of the creation history is achieved by tracking the identification number of the original document data.

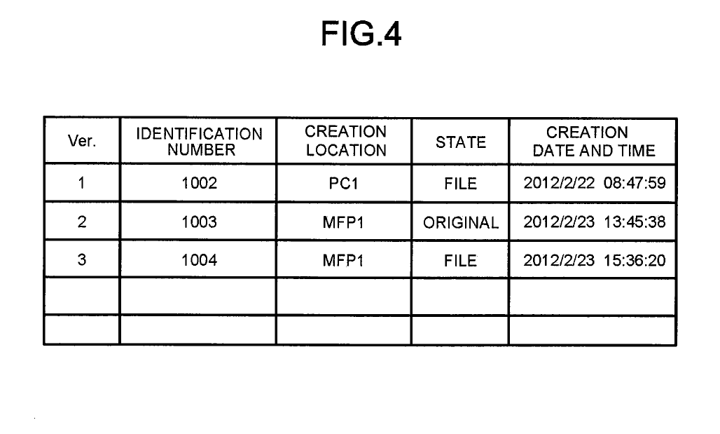

The creation history of the document data may be viewed by referring to the document creation history viewing section 34 provided in the client PC 30. FIG. 4 illustrates a screen on which the creation history of the document data indicated by the document creation history viewing section 34 is displayed. The creation history of the document data with identification number 1004 is shown in FIG. 4. In this embodiment, the processing of copying an original physical document is controlled using such a document creation history.

In one embodiment, a new paper document may be printed at the color-erasable printing section 72 in the color-erasable printing MFP 70 using a color-erasable color material. By feeding the new paper document printed in this way into a color erasing machine, the image formed of the color-erasable color material printed on the document, such as a color-erasable toner, can be erased. In this way, the paper of the document can be reused.

Here, the color-erasable color material presents a special color, for example, blue, so that the user can recognize that the color material is erasable. The special color is referred hereinafter to as a color-erasable color. If the image of the words printed on the original presents a color-erasable color, then the user can recognize that the original is a color-erasable original.

On the other hand, if a color-erasable original is color copied using a general color material, then, the new paper document can be printed in a color-erasable color even if the image of the new paper document cannot be erased, which leads to a problem that it is unclear whether or not the new paper document is color-erasable. Further, the color-erasable color refers to a color which is difficult to be visually recognized, such as, blue, and therefore, in the case in which an original is copied using a general color material, it is requested to copy the original in an easily-recognizable color but not a color-erasable color.

Thus, in one embodiment, if an original as an object to be color copied using a general color material is an original printed using a color-erasable color material (referred hereinafter to as color-erasable original), the color-erasable color will be converted to another color before the copying.

Further, the color conversion is also needed for a color printing in addition to a color copying. That is, the same color conversion is also needed even if the document file serving as the object to be printed is image data obtained by scanning a color-erasable original.

Here, to carry out such a color conversion, it is needed to determine whether or not the object to be color copied or color printed is a color-erasable original. Thus, a document creation history is used to determine whether or not the document data serving as the object to be copied or printed is a color-erasable original printed by the color-erasable printing MFP 70.

In one embodiment, the determination is carried out by the general printing section 52 of the general MFP 50. The general printing section 52 receives the identification number of the document creation information of the printing object while receiving the printing data of the printing object. The general printing section 52 determines whether or not the document data serving as the printing object is a color-erasable original printed by the color-erasable printing MFP 70 based on the identification number received.

Here, if it is determined that the original is a color-erasable original, the color-erasable color image portion contained in the image of the printing data is converted to another color image portion by the printed image conversion section 54 of the general MFP 50. Then, the printing data subject to the color conversion is printed.

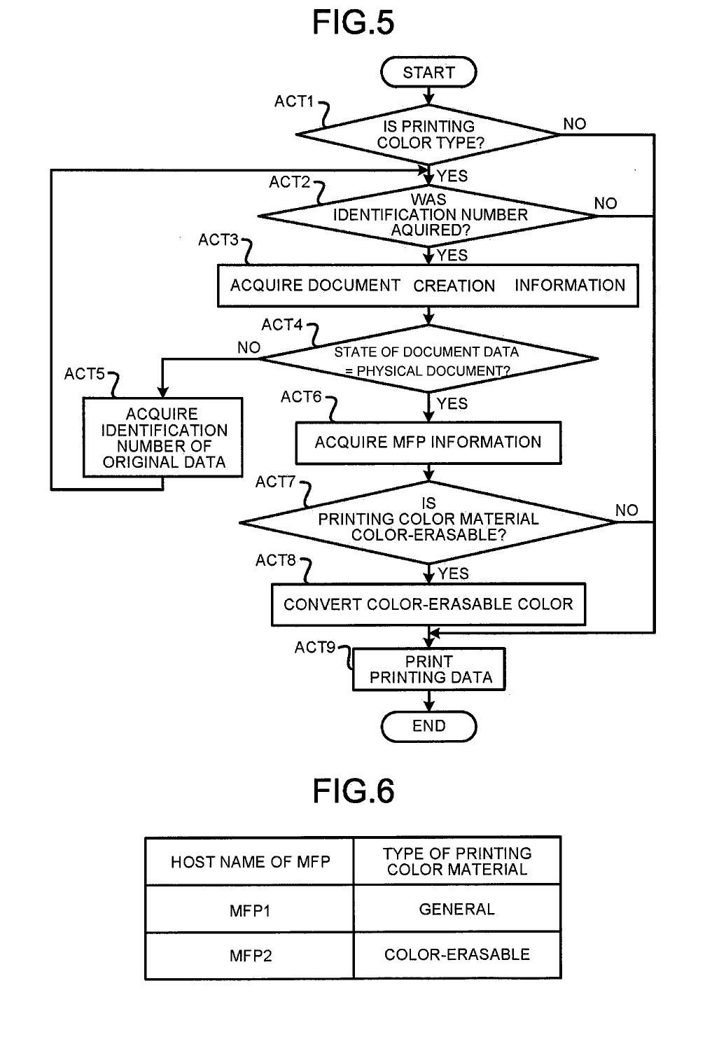

The processing of the general printing section 52 is described with reference to the flowchart shown in FIG. 5. It is assumed here to copy the original physical document managed by identification number 1005 shown in FIG. 3 using the general MFP 50. Moreover, the original physical document managed by identification number 1005 is printed by the color-erasable printing MFP 70 in a color-erasable color.

First, it is determined in ACT 1 whether or not the printing (copying) is a color printing (copying). If it is determined the printing (copying) is a color printing (copying), the flow proceeds to ACT 2. Otherwise, the flow proceeds to ACT9. Here, as the printing is a color printing, thus, the flow proceeds to ACT 2.

In ACT 2, it is determined whether or not the identification number of the document data serving as the printing object can be acquired. If the identification number cannot be acquired, the flow proceeds to ACT 9; otherwise, the flow proceeds to ACT 3. Here, as identification number 1005 can be acquired from the image of the identification mark 2 printed on the original physical document serving as the copying object, the flow proceeds to ACT 3.

In ACT 3, the document creation information corresponding to the identification number is acquired by referring to the document creation information management section 11, then the flow proceeds to ACT 4. Here, the document creation information with identification number 1005 is acquired.

In ACT 4, it is determined whether or not the “state” of the document data is a physical document based on the document creation information acquired in ACT 3. If the state of the document data is ‘physical document’, the flow proceeds to ACT 6; otherwise, the flow proceeds to ACT5. Here, as the state of the document creation information with identification number 1005 is ‘physical document’, the flow proceeds to ACT 6.

In ACT6, the MFP information shown by the “created location” in the document creation information acquired in ACT5 is acquired, then the flow proceeds to ACT7. The MFP information is kept by the MFP information management section 91 comprised in the MFP information management server 90. The general printing section 52 acquires the MFP information kept by the MFP information management section 91 based on the host name of the MFP shown by the “created location” in the document creation information.

FIG. 6 illustrates the MFP information kept by the MFP information management section 91. The MFP information management section 91 manages such MFP information as a type of the printing color material of the MFP recognized by a host name. The printing color material registered for the general MFP ‘MFP1’ is a general color material. Further, the printing color material registered for the color-erasable printing MFP ‘MFP2’ is a color-erasable color material. Here, as ‘MFP2’ is registered as the “created location” of the document creation information with identification number 1005, MFP information corresponding to ‘MFP2’ is acquired from the MFP information management section 91. In this way, it can be known that the printing color material of ‘MFP2’ is a color-erasable color material.

It is determined in ACT7 whether or not the printing color material of the MFP for printing the original is color-erasable. Here, as the MFP information ‘printing color material is color-erasable color material’ is acquired in ACT 6, the flow proceeds to ACT8. If the original is printed using a general color material instead of a color-erasable color material, the flow proceeds to ACT9.

In ACT8, the color-erasable color of the printing data is converted to another color (e.g. black) by the printed image conversion section 54 provided in the general MFP 50. As the color-erasable color is a specific color such as blue, only the specific color in the image of the printing data is replaced with another color.

The printing data is printed in ACT9. If a color conversion to a color-erasable color is carried out in ACT8, then the printing data to which the color conversion is carried out is printed.

Further, if the state of the document data is an ‘electronic file’ but not a ‘physical document’ in ACT4, the flow proceeds to ACT5 to acquire the identification number of the “original document data” shown in the document creation information, and then the flow returns to ACT2 by taking the acquired identification number as a processing object.

For example, it is assumed to print the electronic document file with the identification number 1004 shown in FIG. 3. The general printing section 52 receives the identification number 1004 and the printing data of the electronic document file and starts a processing from ACT2 in the flowchart. At this time, as the document creation information with the identification number 1004 presenting the state is “electronic document file” in ACT 4, then the flow proceeds to ACT 5.

In ACT5, the identification number 1003 is acquired by referring to the “original document data” shown in the document creation information of the identification number 1004. Thus, the flow returns to ACT 2 to continue the processing by taking the identification number 1003 as the processing object. As the document creation information of the identification number 1004 represents that the state is “physical document” in the ACT 4 carried out for the second time, the processing proceeds to ACT 6.

With the structure above, in one embodiment, if the object to be color printed or color copied using a general color material is an original physical document printed using a color-erasable color material, the color-erasable color is converted to another color during the printing and the newly-printed physical document can convey information indicating that the image of the document cannot be erased.

Further, it can be printed when a color-erasable color that is difficult to be visually recognized is converted to a more recognizable color.

### Second Embodiment

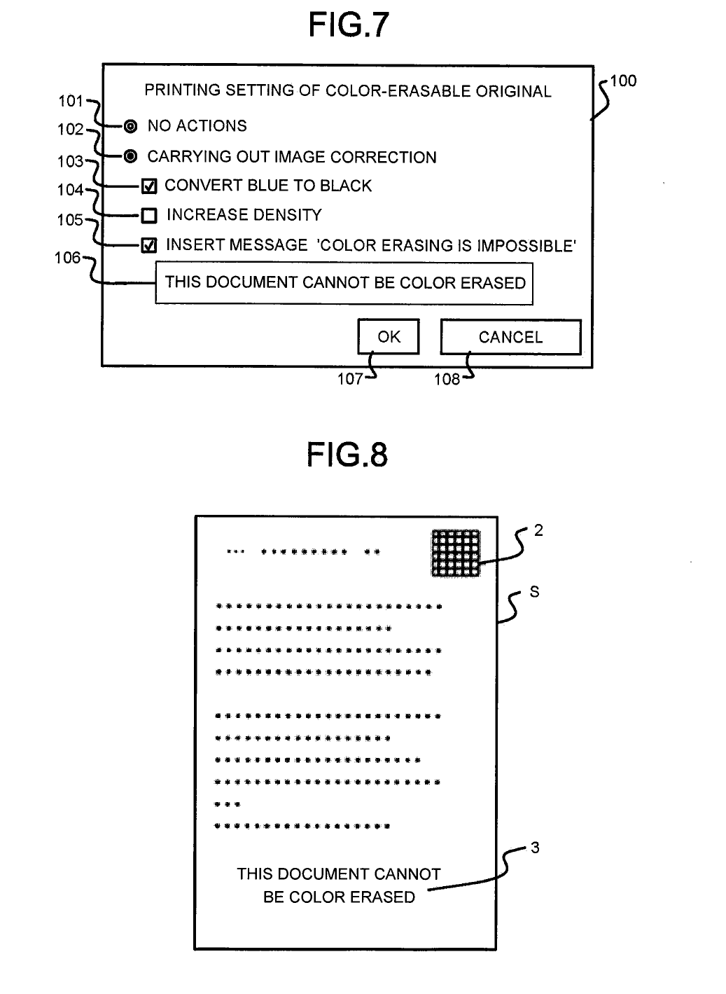

FIG. 7 is a diagram illustrating a printing setting screen for the color-erasable original by the general printing section according to embodiment 2, and FIG. 8 is a diagram illustrating an example of a physical document to be printed set on the printing setting screen shown in FIG. 7.

The general printing section 52 of the general MFP 50 enables the operator to change a print setting using the print setting screen 100 for a color-erasable original shown in FIG. 7. The print setting screen 100 is displayed on the monitor of the client PC 30 or the general MFP 50 for the operator to carry out a change operation.

In FIG. 7, if a general printing mode setting button 101, which displays ‘no actions,’ is selected, then an object to be color printed or color copied using a general color material is printed in the color of the general color material whether or not the original to be printed is formed with a color-erasable color material. In FIG. 7, the general printing mode is not selected.

If the object to be color printed or color copied using a general color material is an original physical document printed using a color-erasable color material, by selecting an image correction mode setting button 102 shown with ‘Carrying out image correction’ the color-erasable color is converted to another color so that the newly created document is printed in the another color. The image correction mode is selected in FIG. 7. If the image correction mode is selected, then a conversion color can be set by selecting a conversion color setting button 103, and the conversion color can be set to be black in FIG. 7. Further, the conversion color may also be converted to another color.

If a density setting button 104 is selected, then the density of the image can be increased. Generally, the density of the image printed using a color-erasable color material tends to be low. In order to print a vivid image, the density can be increased. The density setting button 104 is not selected in FIG. 7.

If a message insertion setting button 105 is selected, the operator can edit an insertion message to notify that the color erasing is impossible to be printed on the new document. For example, a insertion message such as ‘This document cannot be color erased’ is displayed on a message display section 106. Moreover, as shown in FIG. 8, message 3 ‘This document cannot be color erased’ is printed on the newly-printed document S.

That is, if the original serving as original printing data is a color-erasable original, then the user may be mislead that the newly-printed document is color-erasable even if the color of the newly-printed document is converted to black from blue. However, by printing the message, the possibility that the newly-printed document is erroneously inserted into a color erasing machine is avoided.

Further, in each of the above-mentioned embodiments, the identification mark 2 only represents an identification number serving as a basis for document management, however, information may be added to represent whether or not an image can be printed using a color-erasable color material. In this case, whether or not the document is a color-erasable original can be determined by reading the identification mark, without tracking the history of the document.

Further, instead of the QR code, the identification mark 2 may be a barcode, a RFID, or an electronic watermark.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming system, comprising:
a printing section configured to print on a sheet an image formed on an original;
a determination section configured to determine whether or not the image formed on the original is formed with an erasable material; and
a conversion section configured to change a color of the image to be printed by the printing section if the determination section determines that the image formed on the original is formed with the erasable material.

2. The image forming system according to claim 2, wherein
the conversion section is further configured to change a density of the image to be printed by the printing section.

3. The image forming system according to claim 1, wherein
the conversion section is further configured to cause an image part that is not formed on the original to be printed with the image.

4. The image forming system according to claim 3, wherein
the image part conveys information indicating that the image printed on the sheet is not erasable.

5. The image forming system according to claim 1, wherein
the conversion section changes the color of the image to be printed so that the image printed on the sheet is distinguishable from the image formed on the original.

6. The image forming system according to claim 1, further comprising:
a display section configured to display operation information of the image forming apparatus, wherein
the conversion section is configured to cause the display section to display information indicating that the image printed on the sheet is not erasable, if the determination section determines that the image formed on the original is formed with the erasable material.

7. The image forming system according to claim 1, wherein
the determination section determines whether or not the image formed on the original is formed with the erasable material based on identification information of the original that is formed on the original with the image.

8. The image forming system according to claim 7, further comprising:
a management section configured to store correlation between identification information of the original and the image forming apparatus used to formed the image on the original, wherein
the determination section determines whether or not the image formed on the original is formed with the erasable material by referring to the correlation stored in the management section.

9. The image forming system according to claim 8, wherein the management section further stores in the correlation whether or not the image forming apparatus uses erasable material.

10. An image forming system, comprising:
a printing section configured to print on a sheet an image formed on an original;
a determination section configured to determine whether or not the image formed on the original is formed with an erasable material; and
a conversion section configured to cause an image part that is not formed on the original to be printed with the image.

11. The image forming system according to claim 10, wherein
the image part conveys information indicating that the image printed on the sheet is not erasable.

12. The image forming system according to claim 10, wherein
the conversion section is further configured to change a density of the image to be printed by the printing section.

13. The image forming system according to claim 10, further comprising:
a display section configured to display operation information of the image forming apparatus, wherein
the conversion section is configured to cause the display section to display information indicating that the image printed on the sheet is not erasable, if the determination section determines that the image formed on the original is formed with the erasable material.

14. The image forming system according to claim 11, wherein
the determination section determines whether or not the image formed on the original is formed with the erasable material based on identification information of the original that is formed on the original with the image.

15. The image forming system according to claim 14, further comprising:
a management section configured to store correlation between identification information of the original and the image forming apparatus used to formed the image on the original, wherein
the determination section determines whether or not the image formed on the original is formed with the erasable material by referring to the correlation stored in the management section.

16. An image forming method, comprising:
determining whether or not an image formed on an original is formed with an erasable material;
changing an appearance of the image to be printed if it is determined that the image of the original is formed with the erasable material; and
printing the image with the changed appearance.

17. The image forming method according to claim 16, wherein
a density of the printed image is changed.

18. The image forming system according to claim 16, wherein
the printed image is further changed by adding an image part that is not formed on the original.

19. The image forming system according to claim 18, wherein
the image part conveys information indicating that the image printed on the sheet is not erasable.

20. The image forming system according to claim 16, wherein
whether or not the image formed on the original is printed with the erasable material is determined based on identification information of the original that is formed on the original with the image.
